(19) United States
(12) Patent Application Publication
(10) Pub. No.: US 2016/0080244 A1
(43) Pub. Date: Mar. 17, 2016

(54) HOST MOBILITY MESSAGING

(71) Applicants: Alvaro Entrique RETANA, Raleigh, NC (US); Yubing SONG, N/A (CN); HEWLETT-PACKARD DEVELOPMENT COMPANY, L.P., Houston, TX (US)

(72) Inventors: Alvaro Retana, Raleigh, NC (US); Yubing SONG, Beijing (CN)

(21) Appl. No.: 14/786,288

(22) PCT Filed: Apr. 29, 2013
(86) PCT No.: PCT/CN2013/075021

§ 371 Date: Oct. 22, 2015

(51) Int. Cl. H04L 12/755; H04L 29/12; H04L 12/46; H04L 29/08

(52) U.S. Cl. CPC H04L 45/021; H04L 67/24; H04L 61/6022; H04L 12/4641

(57) ABSTRACT

The presence of a host is detected at a first data center. A message is generated at the first data center to indicate the presence of the host. The message has a limited lifetime. The message is transmitted to a second data center.

### BACKGROUND

Network architectures such as data centers, campus networks, and cloud computing networks provide various services to clients. A broad spectrum of industries including healthcare, education, manufacturing, transportation, banking, and government depend on their networks to deliver fast and reliable access to information and services.

### BRIEF DESCRIPTION OF THE DRAWINGS

The following detailed description references the drawings, wherein:

FIG. 1 is a block diagram of a network system, according to one example;

FIG. 2 is a block diagram of a network system, according to one example;

FIG. 3 is a flowchart of a method of transmitting a message indicating the presence of a host, according to one example; and

FIG. 4 is block diagram of a computing device including instructions for transmitting a message indicating the presence of a host, according to one example.

### DETAILED DESCRIPTION

Various aspects of the present disclosure are directed to host mobility messaging. More precisely, various aspects of the present disclosure are directed to advertising the presence of a host in a network architecture. For example, reachable identifiers such as media access control (MAC) address and/or internet protocol (IP) address of a host computing device (e.g., a virtual machine) may be transmitted from a first data center to a second data center.

As explained above, data centers provide various services to clients. The services may be implemented via hosts. In interconnected data centers, a host may be moved from one data center to another. For example, it may be desirable to move a virtual machine between data centers. A host maintains the same address (e.g., IP/MAC address), when migrating from one data center to another. However, due to the mobility of hosts/services, inefficiencies, delays, and/or errors in providing services to the client may result, if the client is not informed of the new location of the host.

For example, when a client seeks to access the moved host, only the previous data center, which no longer includes the moved host, may incorrectly advertise a route to the host. In this case, the route to the host may enter through the previous data center and then flow to a current data center, which holds the moved host, via an interconnect. Thus, as the route does not directly flow to the current data center, this route may be inefficient or asymmetrical.

In another scenario, because route advertisements at an edge of the data centers may be static, both the previous and current data centers may respond with route advertisement to the host. In this case, there may be confusion as to which of the data centers actually includes the moved host. In yet another scenario, no data center may respond with route advertisements, if the previous data center is aware the host has moved but the current data center is not yet aware of the moved host. Further, some traditional methods use dynamic probing to detect host movement. However, scalability decreases with the number of hosts and are highly resource intensive.

Accordingly, examples disclosed herein provide a solution for explicitly and dynamically advertising a host route, based on a current location of the host that is event driven and network based. The described solution provides accurate host route signaling without the potential instability and overhead of active detection, or the requirement for integration with other systems or changes to existing protocols.

In one example, a network system includes a first data center. The first data center includes a first network unit. The network unit is to detect a presence of a host at the first data center. The first network unit is to generate a message having a limited lifetime, the message to indicate the presence of the host at the first data center. The first network unit is further to transmit the message to a second data center.

In another example, a method includes detecting a presence of a host at a first data center. The method includes generating a message indicating the presence of the host, where the message has a limited lifetime. The method also includes transmitting the message to a second data center, and updating a routing table at the second data center to include a path to the host in response to the message.

In another example, a non-transitory computer-readable medium includes instructions that, when executed by a processor of a device, cause the processor to detect a presence of a host at a first data center and generate a message indicating the presence of the host, where the message has a limited lifetime, and where the message includes a path to the host. The instructions are executable to transmit the message to a second data center, the second data center to update a routing table of the second data center to include the path to the host.

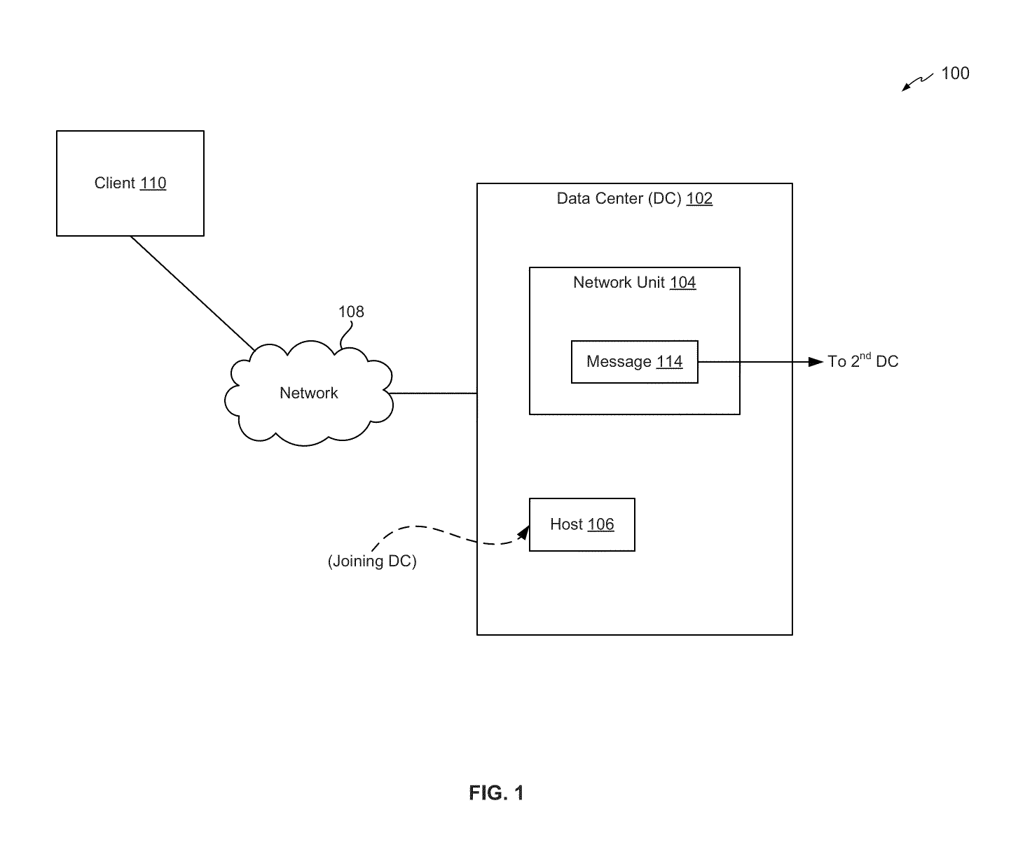

FIG. 1 depicts a block diagram of a network system, according to one example. Network system 100 includes a client 110 connected to a data center 102 via network 108. The example of FIG. 1 depicts a host 106 joining data center 102. For example, host 106 may be joining data center 102 from a second data center (not shown).

Data center 102 may be any type of facility used to house computer systems and associated components, such as telecommunications and storage systems. Data center 102 is shown to include a network unit 104 and host 106. Further, data center 102 is shown to interface with client 110 via network 108. Although FIG. 1 depicts a data center, it should be noted that the described examples may relate to any mobility scenario, where host 106 may move between devices and/or computing facilities such as campus networks and cloud computing networks.

Host 106 and client 110 may be part of a client-server architecture, where client 110 may request a service from host 106. For example, host 106 may run at least part of an operating system (OS) and/or application of client 110. Client 110 may include, for example, a workstation, terminal, mobile computer, desktop computer, thin client, and the like.

Host 106 may be a physical computing device running software and/or a virtualized computing device to provide a resource or service to a service requester, such as client 110. Examples of host 106 may include a physical host, a virtual host, a virtual machine, a server, and the like. Host 106 may include a processor (not shown) and a machine-readable storage medium (not shown), if the host 106 is a physical computing device. The processor may be, at least one central processing unit (CPU), at least one semiconductor-based microprocessor, at least one graphics processing unit (GPU), other hardware devices suitable for retrieval and execution of instructions stored in the machine-readable storage medium. The machine-readable storage medium may be any electronic, magnetic, optical, or other physical storage device that contains or stores executable instructions.

Host 106 may also relate to being a method for hosting multiple domain names (with separate handling of each name) on a single server (or pool of servers), if the host 106 is a virtual host. Further, host 106 may be a simulation of a machine (abstract or real) that is usually different from a target machine that is being simulated on, if the host 106 is a virtual machine).

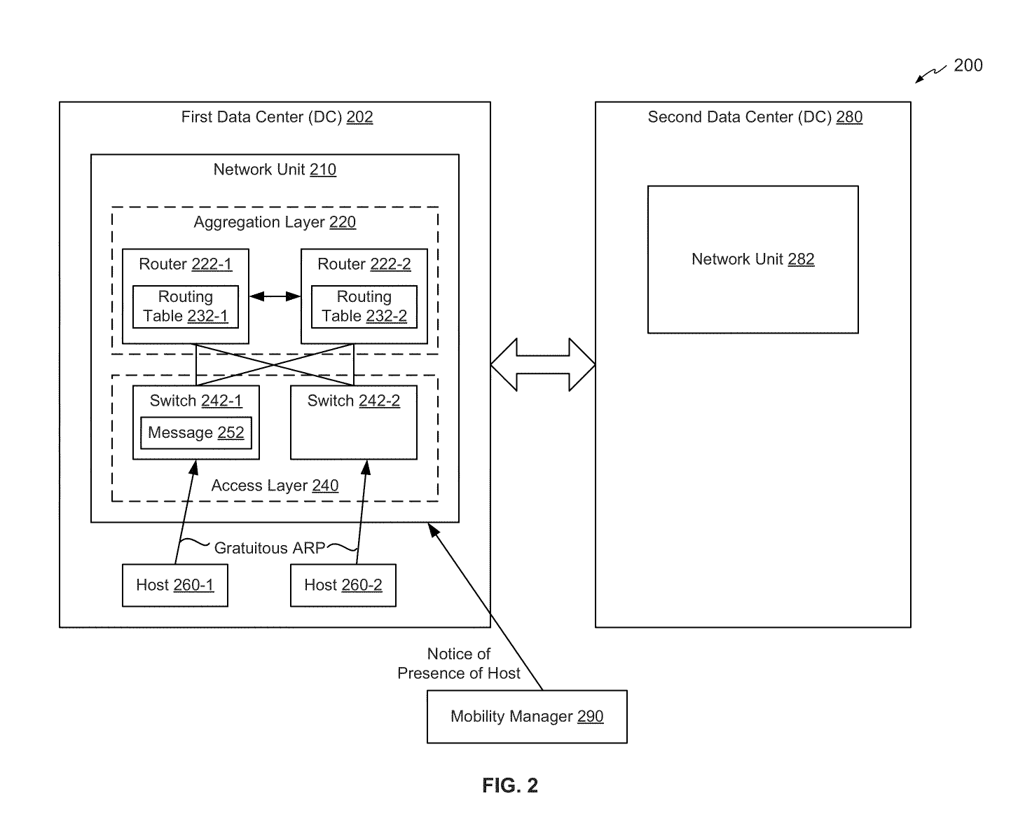

Although not shown, network unit 104 may include various types of devices that process packets of data, such as layer 3 (L3) switches, layer 2 (L2) switches, routers, hubs, bridges, high-speed cables, and the like. In other examples (e.g., FIG. 2), network unit may include a routing table, which may be a data table stored in a router or a networked computer that lists routes to particular network destinations such as the host 106. For example, the routing table may correlate an internet protocol (IP) address with a port number and/or media access control (MAC) number.

In the example of FIG. 1, host 106 may join data center 102. For example, host 106 may have just been created at data center 102 or migrated to data center 102 from another data center in the network system 100. Network unit 104 may detect the presence of the host 106 at data center 102. In some examples, the host 106 may announce its presence at the data center 102 by transmitting a gratuitous address resolution protocol (ARP) packet to the network unit 104. The gratuitous ARP packet may include an IP address and/or MAC address of the host 106. In other examples, a mobility manager (not shown) in the network system 100 may notify the network unit 104 of the presence of the host 106 at the data center 102.

Upon detecting the presence of host 106 at the data center 102, network unit 104 may generate a message 114 to indicate the presence of the host 106 at the data center 102. In some examples, the message 114 has a limited lifespan and is set to expire (e.g., removed or discarded) after the lifespan. Network unit 104 may transmit the message 114 to one or more other data centers in the network system 100. The message 114 includes at least one of an IP address and a MAC address of host 106. Messaging between data centers 102 in the network system 100 may include any type of routing protocol (e.g., layer 2 routing protocols or layer 3 routing protocols).

Network unit 104 may further update the routing table at the data center 102 to include a path to the host 106. For example, one or more routing tables of routers may be updated to correlate a port number and/or MAC address with the IP address of the host 120. Similarly, when the message 114 is received at a second data center, a network unit of the second data center updates one or more routing tables of routers at the second data center to include the path to the host 106. Moreover, a previously known path to the host (at data center 106 and the second data center) is removed and replaced with the updated path to the host 106. For example, one or more routing tables of routers may be updated to remove previous correlation between the port number and/or MAC address with the IP address of the host 106.

Further, because the message 114 has a limited lifetime, the message 114 is discarded at all data centers (i.e., data center 102 and second data centers) in the network system 100, thereby reducing and/or eliminating overheads associated with advertising the host 106 route. Moreover, the messaging described herein is event driven and network-based that relies on explicit signaling of host route to data centers, and does not require polling of data centers to determine a location of the host 106. In addition, the described solution may be implemented in existing protocols, without additional upgrades or network components. Accordingly, a location of the host 106 may be dynamically determined when the host 106 migrates between data centers because a data center to which the host 106 has moved informs other data centers of the location of the host 106.

FIG. 2 is a block diagram of a network system, according to one example. In the network system 200 of FIG. 2, a first data center 202 is interconnected to a second data center 280. Host 260 may join the first data center 202. For example, host 260 may be joining the first data center 202 from the second data center 280.

The first data center 202 and the second data center 280 may be any type of facility used to house computer systems and associated components, such as telecommunications and storage systems. Here, the first data center 202 and the second data center 280 are shown to be interconnected, such as via an L2 or L3 extension. The interconnect between the first data center 202 and the second data center 280 may provide flexibility for deploying applications and/or resiliency schemes. The host 260 maintains the same IP address in both the first data center 202 and the second data center 280.

The first data center 202 includes a network unit 210 and a plurality of hosts 260-1 to 260-2. The network unit 210 and hosts 260-1 to 260-2 of FIG. 2 may at least respectively include the functionality and/or hardware of the network unit 104 of FIG. 1. While the first data center 202 is primarily discussed below, the second data center 280 may include hardware and/or functionality similar to the first data center 202.

As explained above, the message 252 generated by the first data center 202 is to indicate the presence of the host 260 at the first data center 202, where the message has a limited lifetime. Thus, the message 252 is removed the first data center 202 and the second data center 280 after the lifetime of the message 252 has expired. In certain examples, the lifetime of the message 252 is a predetermined time sufficient for the second data center 280 to receive the message 252 and updates its routing tables accordingly. For example, the lifetime of the message 252 may be a few seconds. In some examples, as a result of the message 252, the second data center 280 will update one or more routing tables 232 and cease to advertise a path or route for incoming traffic to the host 260.

As shown in FIG. 2, hosts 260-1 and 260-2 interface with an access layer 240 of the network unit 210. For example, hosts 260-1 and 260-2 interface with switch 242-1 and 242-2, respectively, of access layer 240. Access layer 240 may generally include L2 devices, such as L2 switches and hubs that interface with end nodes, such as hosts, computer clusters and the like.

Access layer 240 further interfaces with an aggregation layer 220, which may include L3 devices, such as local area network (LAN)-based routers and L3 switches. The aggregation layer 220 may ensure that packets are properly routed between subnets and virtual LANs (VLANs). Here, aggregation layer 220 is shown to include two routers 222-1 and 222-2, each having a routing table 232-1 and 232-2, respectively. Network unit 210 may also include a core layer (not shown), which may include the backbone of a network, such as high-end switches and high-speed cables. The core layer may be concerned with speed and reliable delivery of packets.

Network system 200 may also include a mobility manager 290. In some examples, mobility manager 290 may notify network unit 210 of the presence of host 260 at the first data center 202. For example, mobility manager 290 may transmit a packet to the network unit 210 that indicates the presence of host 260 at the first data center 202. In other examples, host 260 may announce its presence at the first data center 202 by transmitting a gratuitous ARP to the network unit 210.

Responsive to detecting the presence of host 260 at the first data center 202, network unit 210 generates message 252 having a limited lifetime. In particular, switch 242 of network unit 210 includes functionality for generating message 252, such as control logic and/or memory. In addition or as an alternative, switch 242 may be implemented as a series of instructions encoded on a machine-readable storage medium and executable by a processor. Message 252 may be forwarded along until a L3 device having a routing table is reached. For example, switch 242 may forward message 252 to router 222 having a routing table 232. Further the network unit 210 of the first data center 202 transmits the message 252 to the network unit 282 of the second data center 280. After a predetermined time, the message 252 is removed from the first data center 202 and from the second data center 280, where the predetermined time is sufficient (e.g., in the order of a few seconds) for the second data center 280 to receive the message 252 and to update routing tables at the second data center 280.

While examples show the aggregation later 220 having L3 devices and the access layer 240 having L2 devices, L2 and L3 devices may be found in any combination in the aggregation layer 220 and the access layer 240. Further, examples may include more or less hosts 260, switches 242 and/or routers 222 than those shown in the first data center 202.

When there is a plurality of hosts 260 in the network system 200 migrating to the first data center 202, a large number of messages 252 may be generated to indicate the presence of the hosts 260 at the first data center 202. To reduce bandwidth and/or memory resources strain, and to improve efficiency, communication related to updating routing tables 232 may be compacted and/or summarized. For example, where there are a plurality of host routes corresponding to a plurality of hosts 260 having contiguous IP addresses, network unit 210 may generate message 252 including a partially masked IP address that covers a range of contiguous IP addresses, including the IP addresses of the hosts 260.

Accordingly, lesser addresses and/or shorter addresses may be transmitted through the network unit 210 than if each of the individual IP address was transmitted. To illustrate, if there are 8 contiguous IP addresses, a single IP address that has last 3 bits masked may be transmitted instead (i.e., 2³=8). An amount of masking of host routes may y be based on policy considerations. For example, a length threshold indicating a minimum length for the masked IP address and/or a percentage threshold indicating a minimum percentage of the affected hosts 260 to be included in the masked IP address may be implemented. Accordingly, message 252 may be generated to include host routes 260 with a plurality of masked addresses to group a plurality of contiguous addresses to be added to the routing tables 232 of first data center 202 and second data center 280.

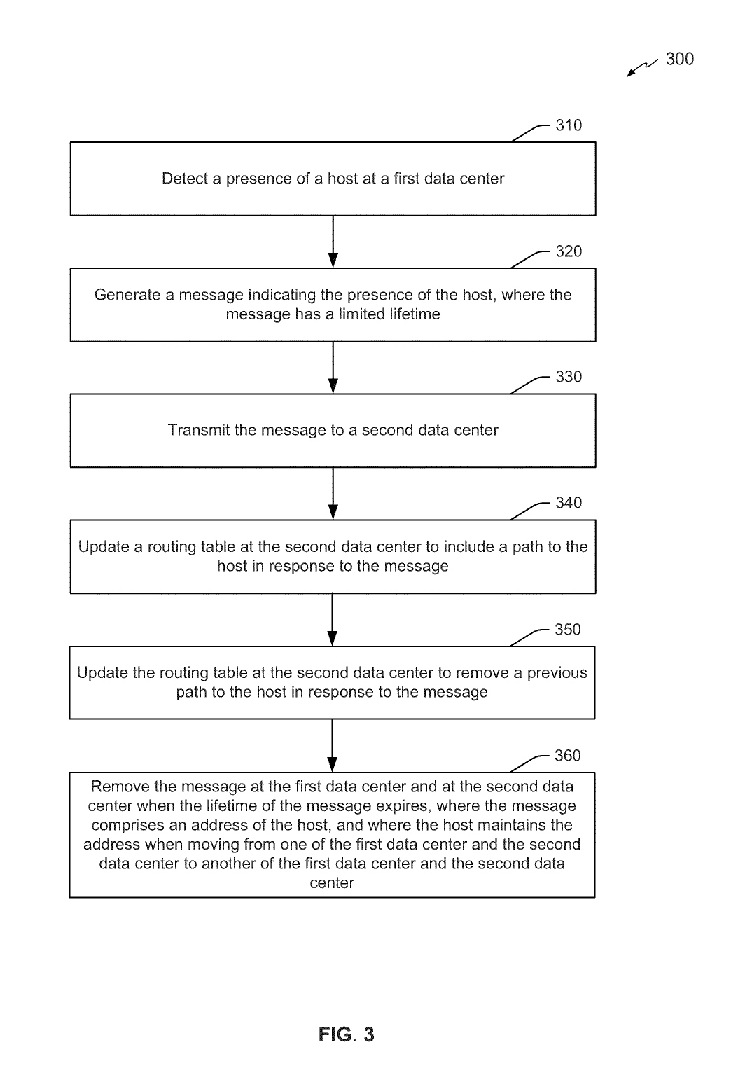

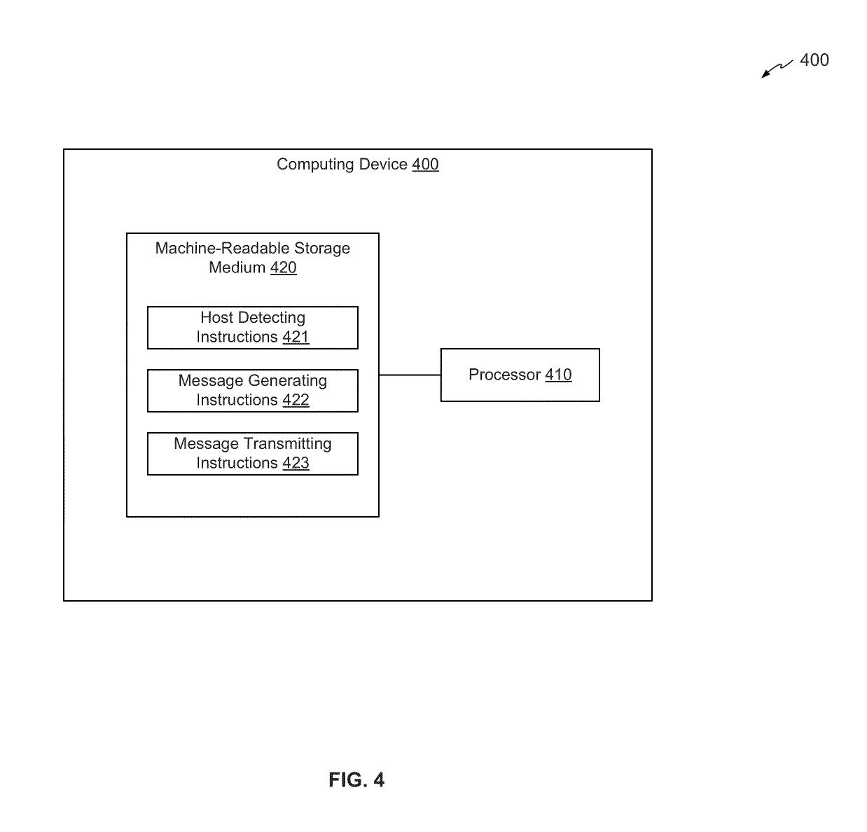

FIG. 3 is a flowchart of a method 300 of transmitting a message indicating the presence of a host, according to one example. Although execution of method 300 is described with reference to the component of network systems 100 and 200 of FIGS. 1 and 2, respectively, other suitable components for execution of method 300 will be apparent to those of skill in the art. Additionally, the components for executing method 300 may be spread among multiple devices. Method 300 may be implemented in the form of executable instructions stored on a machine-readable storage medium, such as non-transitory machine-readable storage medium 420 of FIG. 4.

Method 300 includes detecting a presence of a host at a first data center, at 310. For example, network unit 104/210 may detect the presence of host 106/260 at data center 102/202. In one example, detection may be via a gratuitous ARP transmitted by host 106/260. In another example, mobility manager 290 may announce the presence of host 106/260 at the data canter 102/202.

Method 300 also includes generating a message indicating the presence of the host, where the message has a limited lifetime, at 320. For example, network unit 104/210 may generate message 114/252 in response to detecting the presence of host 106/260 at data center 102/202. Message 114/252 may have a predetermined lifetime, where the message is removed after expiration of a predetermined time (e.g., a few seconds).

Method 300 includes transmitting the message to a second data center, at 330. For example, message 114/252 is transmitted from network unit 104/210 to network unit 282 of second data center 280.

Method 300 includes updating a routing table at the second data center to include a path to the host in response to the message, at 340. For example, one or more routing tables at the second data center 280 are updated to include a path to the host 106/260.

Method 300 includes updating a routing table at the second data center to remove a previous path to the host in response to the message, at 350. For example, one or more routing tables of the second data center 280 are updated to remove a previous path to the host 106/260. In some examples, the host 106/260 was previously at the second data center 280 before migrating to the first data center 102/202. Thus, the second data center 280 was previously advertising a path to the host 106/260 at the second data center 280. Accordingly, the old path is removed to reflect the new location of the host 106/260.

Method 300 further includes removing the message at the first data center and at the second data center when the lifetime of the message expires, at 360. For example, because message 114/252 has a limited lifetime/lifespan, message 114/252 is removed at the first data center 102/202 and at the second data center 280 when the lifetime expires (e.g., a few seconds). In examples, message 114/252 includes an address of the host 106/260 (e.g., IP and/or MAC addresses), and host 106/260 maintains the address when migrating between the first data center 102/202 and the second data center 280.

FIG. 4 is a block diagram of a computing device including instructions for transmitting a message indicating the presence of a host, according to one example. In the example of FIG. 3, computing device 300 includes a processor 410 and a machine-readable storage medium 420. Computing device 400 may be, for example, a router, a switch, a gateway, a bridge, a server, or any other type of device capable of executing instructions 412, 422, and 423. In certain examples, computing device 400 may be included or be connected to additional components such as storage drive, a processor, a network element, etc.

Processor 410 may be one or more central processing units (CPUs), microprocessors, and/or other hardware devices suitable for retrieval and execution of instructions stored in machine-readable storage medium 420. Processor 410 may fetch, decode, and execute instructions 421-423. As an alternative, or in addition to retrieving and executing instructions, processor 410 may include one or more electronic circuits comprising a number of electronic components for performing the functionality of one or more instructions 421-423.

Machine-readable storage medium 420 may be an electronic, magnetic, optical, or other physical storage device that stores executable instructions. Thus, machine-readable storage medium 420 may be, for example, Random Access Memory (RAM), an Electrically-Erasable Programmable Read-Only Memory (EEPROM), a storage drive, an optical disc, and the like. As such, machine-readable storage medium 420 can be non-transitory. As described in detail below, machine-readable storage medium 420 may be encoded with executable instructions for generating and transmitting a message indicating the presence of a host.

Host detecting instructions 421 may detect a presence of a host at a first data center. For example, detection may be based on at least one of a gratuitous ARP transmitted by the host and a notice received from a mobility manager.

Message generating instructions 422 may generate a message indicating the presence of the host, where the message has a limited lifetime, and where the message includes a path to the host. For example, in response to detecting the presence of the host at the first data center, a network unit of the first data center may generate the message having a limited lifetime. The message to be removed after expiration of a predetermined time.

Message transmitting instructions 423 may transmit the message to a second data center, the second data center to update a routing table of the second data center to include the path to the host. For example, the message includes an IP address and/or MAC address of the host. Thus, the second data center may update routing tables to reflect the new location of the host.

In the foregoing description, numerous details are set forth to provide an understanding of the present disclosure. However, it will be understood by those skilled in the art that the present disclosure may be practiced without these details. While the disclosure has been described with respect to a limited number of examples, those skilled in the art will appreciate numerous modifications and variations therefrom. It is intended that the appended claims cover such modifications and variations as fall within the true spirit and scope of the disclosure.

What is claimed is:

1. A network system comprising:
a first data center comprising a first network unit, the first network unit to:
detect a presence of a host at the first data center;
generate a message having a limited lifetime, the message to indicate the presence of the host at the first data center; and
transmit the message to a second data center.

2. The network system of claim 1, the first network unit comprising a first routing table, the first network unit further to update the first routing table to include a path to the host.

3. The network system of claim 2, the second data center comprising a second network unit, the second network unit to:
receive the message from the first data center; and
update a second routing table of the second data center to remove a previously known path to the host and to include the path to the host in response to the message,
wherein the host was previously at the second data center prior to migrating to the first data center.

4. The network system of claim 3, wherein,
the first data center is interconnected to the second data center, and
the first network unit of the first data center is to exchange routing information with the second network unit of the second data center.

5. The network system of claim 3, wherein the message comprises a host route with a plurality of masked addresses to group a plurality of contiguous addresses to be added to the first routing table and to the second routing table.

6. The network system of claim 2, wherein,
the first network unit includes a first switch and a first router, the first switch to interface between the first router and the host, and the first router to include the first routing table,
the first switch is included in an access layer of the first network unit, and
the first router is included in an aggregation layer of the first network unit.

7. The network system of claim 1, wherein the message comprises an address of the host, wherein the address comprises at least one of an internet protocol (IP) address and a media access control (MAC) address.

8. The network system of claim 7, wherein the host maintains the address when migrating from one of the first data center and the second data center to another of the first data center and the second data center.

9. The network system of claim 1, the first network unit to detect the presence of the host based on at least one of:
an announcement transmitted by the host in response to joining the first data center, wherein the announcement comprises a gratuitous address resolution protocol (ARP); and
a notice of the presence of the host received from a mobility manager of the network system.

10. The network system of claim 1, wherein the message is discarded at the first data center and at the second data center when the lifetime of the message expires.

11. The network system of claim 1, wherein the host comprises at least one of a physical host, a virtual host, and a virtual machine (VM).

12. A method comprising:
detecting a presence of a host at a first data center;
generating a message indicating the presence of the host, wherein the message has a limited lifetime;
transmitting the message to a second data center; and
updating a routing table at the second data center to include a path to the host in response to the message.

13. The method of claim 12, further comprising:
updating the routing table at the second data center to remove a previous path to the host in response to the message; and
removing the message at the first data center and at the second data center when the lifetime of the message expires,
wherein the message comprises an address of the host, and
wherein the host maintains the address when moving from one of the first data center and the second data center to another of the first data center and the second data center.

14. A non-transitory computer-readable medium comprising instructions that, when executed by a processor of a device, cause the processor to:
detect a presence of a host at a first data center;
generate a message indicating the presence of the host, wherein the message has a limited lifetime, and wherein the message includes a path to the host; and
transmit the message to a second data center, the second data center to update a routing table of the second data center to include the path to the host.

15. The non-transitory computer-readable medium of claim 14, the processor further to:
detect the presence of the host based on a gratuitous address resolution protocol (ARP) packet received from the host; and
update a routing table of the first data center to include the path to the host.
